(19) United States
(12) Patent Application Publication
(10) Pub. No.: US 2004/0111275 A1
(43) Pub. Date: Jun. 10, 2004

(54) Methods for marketing and generating revenue from edible thin films

(76) Inventors: David B. Kroll, Chicago, IL (US); Steven P. Barton, Chicago, IL (US); Donna M. Dikselis, Oak Lawn, IL (US)

Correspondence Address: BELL, BOYD & LLOYD LLC, P. O. BOX 1135, CHICAGO, IL, 60690-1135, US

(21) Appl. No.: 10/295,320

(22) Filed: Nov. 15, 2002

(51) Int. Cl. G06F 17/60

(52) U.S. Cl. 705/1

(57) ABSTRACT

Methods of generating revenue and marketing confectionery products including edible thin films are provided. In part, the edible thin films are provided in a variety of different forms that vary in flavor, color, shape, and mouthfeel.

### BACKGROUND OF THE INVENTION

The present invention generally relates to the marketing of edible compositions. More specifically, the present invention relates to the marketing of confectionery products including edible thin films.

It is of course known to sell a variety of edible products including confectionery products. Confectionery products typically refer to edible products that are sweet such as candy, chewing gum, and other sugar or sweetener-containing compositions. A variety of confectionery products are marketed by a large number of companies. These products include hard candies, pressed tablets, chewing gum, both sugarless and sugar-containing, bubble gum, gummi candies, liquid candies, chewy confections, and powdered candies. The variety and types of confectionery products continues to evolve and grow.

In part, this evolution is dictated by the need to continue to provide new and different products to the consumer. Although a number of confectionery products have been marketed for decades, e.g., certain chewing gums, a number of consumers want new products. This is especially true of the young consumer that desires a new product that was not available heretofore. In addition, the tastes of the consumer continues to change. Products that were not popular a few years ago may now find widespread acceptance and vice versa.

A number of different companies market and manufacture confectionery products. Some companies will specialize in only one such confectionery product, e.g., chewing gum, while others will sell a number of different confectionery products. However, each of the different confectionery products are typically branded with a distinct brand name to distinguish one type of product from another.

As used herein, the term “confectionery product” broadly refers to products that are designed to be principally placed in the mouth of the consumer and chewed or allowed to dissolve therein. Such products include a sweetener or sugar and are not principally designed to deliver to the consumer a medicament or nutritional value, e.g., a vitamin or food. As used herein, confectionery product therefore includes a recently marketed edible product, edible films.

Edible film products are designed to adhere to and rapidly dissolve in the mouth of the consumer. Edible films can provide flavor and/or oral care agents, e.g., breath freshening to the consumer. Such films typically include a film former and flavor or other ingredient. See, for example, U.S. Pat. No. 5,948,430 and U.S. Application Publication No. US2001/0022964 A1.

Edible film products are provided to the consumer in strip form. The strips are usually sized so that they can be placed on the tongue of a consumer. In this regard, the edible film strips typically have a size of a postage stamp or slightly larger. These strips preferably have a supple texture and are non-self adhering.

One type of edible film product is distributed by Pfizer Consumer Healthcare under the name Listerine® PocketPaks™. The Pfizer edible film product is packaged in a plastic container that includes a top that can open along a hinge. A stack of strips are located in an interior of the package one on top of another. The package is designed so that the consumer can open the container and remove one strip from the stack with his or her finger.

Although current edible film strips and packaging provide a viable product, there are some issues with the design. One issue is manufacturing the edible film strip products. A further potential issue is the way the edible film products are dispensed or accessed. As noted above, these products can be provided in a stacked formation requiring the consumer to slide off a strip from the stack with his finger. Sharing of the product by consumers can cause concerns.

Of course, it has been known to provide edible products such as confectionery products in a variety of shapes and forms. Confectionery products have been molded, extruded, or otherwise shaped into various forms over the years. For example, bubble gum has been formed into shapes such as flat sticks, cylinders, cubes, cigars, shredded chew, and the like. By way of example, U.S. Pat. No. 4,882,175 discloses a method and an apparatus for forming a confectionery product into a rolled or tape form.

It is generally known that providing a confectionery product in a novelty form can enhance the marketability of a product, particularly to young consumers. Edible films could benefit from such new, novel forms.

### SUMMARY OF THE INVENTION

Generally, the present invention provides methods for generating revenue from confectionery products and methods of marketing same. For example, pursuant to the present invention, a variety of methods of generating revenue and marketing edible thin films are provided.

In an embodiment of the present invention, a method for marketing confectionery products is provided. The method comprises the steps of selecting a brand name for a confectionery product and using the brand name on at least three different forms of confectionery products.

In an embodiment, the forms of confectionery products are chosen from the group consisting of chewing gum, mints, edible thin film, and candy. If desired, the brand name is used for a period of time with a first of the three forms before it is used with a second or third of the three forms. Likewise, the brand name can be used for a period of time with a first and second of the three forms before it is used with a third of the three forms. Of course, the brand name can be used simultaneously with all three of the forms. In an embodiment, the brand name is used in the same font on all three different forms of confectionery products.

In another embodiment of the present invention, a method of marketing products is provided. The method comprises the steps of selling a chewing gum product, selling a mint product, and selling an edible thin film product, wherein each of the chewing gum, mint, and edible thin film products are sold with a common brand name as well as a common distributor's name. In an embodiment, the edible thin film provides breath freshening properties. In another embodiment, the method of marketing includes the step of selling a candy with the common brand name.

In an embodiment, the chewing gum product is sold with the common brand prior to the sale of the mint product and edible thin film product. In an embodiment, only one flavor of chewing gum and/or mint is sold under the common brand name. In another embodiment, more than one flavor of chewing gum and/or mint is sold under the common brand name.

Furthermore, in an embodiment, the present invention provides a method of providing edible thin film products comprising the steps of providing edible thin film products that have a plurality of different geometric cross-sectional shapes. In an embodiment, the products having different geometric cross-sectional shapes are packaged separately. By way of example, the geometric cross-sectional shapes can be chosen from the group consisting of rectangle, circle, triangle, hexagon, and oval.

Still further, in an embodiment of the present invention, a method of generating revenues is provided comprising the steps of marketing a line of edible thin film products that includes edible thin films that vary in at least color and flavor. In an embodiment, the edible thin film products that vary in color and flavor are packaged separately.

In yet another embodiment of the present invention, a method of generating revenues is provided comprising the steps of manufacturing an edible film that has a color that is suggestive of the flavor of the edible film when it is ingested by the consumer and selling the edible film to a consumer.

In an embodiment, the flavors are chosen from the group consisting of lemon, orange, cherry, grape, and lime and the colors are chosen from the group consisting of yellow, orange, red, purple, and green. In an embodiment, different flavor edible thin films are packaged together.

Moreover, in a further embodiment of the present invention, a method of marketing edible thin films is provided comprising the steps of manufacturing edible thin films that are designed to be sold during a specific season due to a shape, design, or coloration of the edible film. In an embodiment, the season is chosen from the group consisting of Christmas, Halloween, Valentine's Day, and Thanksgiving.

In a further embodiment of the present invention, a method of marketing edible thin films is provided comprising the step of providing edible thin films that include a design that is indicative of a region wherein the edible film is designed to be distributed. In an embodiment, the design is a logo of a sports team.

And, in an embodiment, the present invention provides a method of marketing edible thin films comprising the step of providing a plurality of edible thin films under a single distributor's name. The edible thin films varying in at least three of the following characteristics: flavor; shape; color; and mouth sensation.

Yet, in an embodiment of the present invention, a method of marketing edible thin films is provided comprising the steps of providing a plurality of edible thin films that provide a different characteristic chosen from the group consisting of flavor, taste, and mouth sensation, and packaging the edible film in a package that indicates the different flavor, taste, or mouth sensation due to the shape, color or indicia on the package.

Still, a further embodiment of the present invention provides a method for marketing confectionery products comprising at least two different types of confections under a single brand name wherein the different forms are combined in a single package in which the single package comprises separate compartments suitable for dispensing each form.

In an embodiment, the separate compartments of the single package are refillable and the refills can be purchased separately from the single package.

In an embodiment, at least the two types of confectionery products are in individual primary packaging suitable for dispensing each form and the primary packaging for each form are then combined with a secondary packaging element, containing a brand identifying element common to the primary packaging comprising a packaging chosen from the group consisting of plastic overwrap, metal tin, vacuum formed plastic mold, injection molded plastic, and corrugated or paper board box providing a single offering for same.

In an embodiment, the single brand name in which the different confections are packaged in packaging which contains at least one single common element to each confectionery form.

It is an advantage of the present invention to provide improved methods of generating revenue from confectionery products.

Moreover, an advantage of the present invention is to provide improved methods of marketing confectionery products.

Furthermore, an advantage of the present invention is to provide an improved methods for marketing edible thin film products.

Another advantage of the present invention is to provide improved methods of generating revenue from edible thin film products.

Still further, an advantage of the invention is that it provides improved methods of branding products.

Further, an advantage of the present invention is to enhance the marketability of edible thin film products.

Additional features and advantages of the present invention are described in, and will be apparent from, the detailed description of the presently preferred embodiments and the drawings.

### BRIEF DESCRIPTION OF THE DRAWINGS

FIG. 1 illustrates an embodiment of an edible thin film of the present invention.

FIG. 2 illustrates an embodiment of an edible thin film product in a package.

### DETAILED DESCRIPTION OF THE INVENTION

The present invention provides improved methods of generating revenue from confectionery products and edible thin film products as well as methods of marketing same. As used herein the term “edible thin film” refers to compositions that include a film-former substrate and are designed to adhere to at least a portion of the oral cavity of a consumer and rapidly dissolve therein. “Rapidly dissolve” means that the substrate dissolves in less than 25 seconds, preferably less than 15 seconds and most preferable less than 10 seconds. To “dissolve” means to substantially lose the shape and form of the substrate. An example of an edible thin film product is the Listerine® PocketPaks™ oral care strips distributed by Pfizer.

As noted in the Background of the Invention, as used herein, “confectionery products” refer to products that are designed to be chewed and/or dissolved in the mouth of a consumer and include sugar or a sweetener and are not principally designed to deliver a medicament or provide nutrition to the consumer.

In general, the present invention provides methods of marketing confectionery products. As previously noted, examples of confectionery products include chewing gum, hard candies, pressed tablets, chewy confections, liquid candies, gummi candies, chocolates, and edible thin films. In an embodiment of the present invention, the method of marketing confectionery products includes marketing at least three different forms of confectionery products, e.g., pressed tablets, chewing gum, and edible thin films, using the same brand name. As used herein, “brand name” refers to a designator for a product or a group of products. An example of a brand name is the “Eclipse” trademark that is used by the Wm. Wrigley Jr. Company.

By using the same brand name on different confectionery products, customer loyalty can be established. This loyalty can extend not only through one product line but different product lines, i.e., different confectionery products.

For example, pursuant to the present invention, a pressed tablet product, a chewing gum, and a thin film will all include the same brand name. In addition to including the brand name, the products will also include, preferably, the name of the distributor and/or manufacturer. If desired, each of the different products may include other product identifiers. However, it is important that they each include the same brand name so the consumer associates all three products with the same brand name even though the products are different.

Preferably, the brand name will be used on the package containing the confectionery product in the same manner. Therefore, the brand name preferably will be in the same design and font on each of the packaging for the products. However, it is possible that the brand name can have a different design, font, color, or variation from product to product.

Pursuant to the present invention, it is not necessary for a new brand name to be selected and used on all three different confectionery products. In this regard, it is possible to expand a brand name into other areas. For example, a brand name that has been associated with a chewing gum can be used on an edible thin film, pressed tablets or other confectionery products or cosmetic compositions including, but not limited to, toothpaste, mouthwash, dental floss, mouth spray, and denture cleaner. Thus, it is possible to increase the marketability of a new product, such as an edible thin film, by using an established brand name on a new product or product line, thereby creating immediate customer recognition and loyalty.

Any of a variety of known confectionery products or cosmetic agents can be used pursuant to the present invention. Some such products such as chewing gum, pressed tablets, hard-boiled candies, toothpaste, mouthwash, and mouth spray are well known in the art.

In addition to providing methods of generating revenue and marketing confectionery products, the present invention also provides methods of generating revenue and marketing specific confectionery products such as edible thin films.

Edible thin films can be formed by a variety of different processes. One such process is as follows: (1) an aqueous solution is formed by blending film-forming materials together with water and are agitated until the powdered materials are mostly hydrated and few lumps are present; (2) to this mixture, plasticizers, softening agents, colors, sweeteners, cooling agents, and active ingredients are blended together to form a homogeneous solution; and (3) this solution is then cast onto a suitable carrier, and dried to form a film.

The carrier material should be impermeable to the film coating, allowing the film coating to disperse evenly onto the carrier. This also allows for ease of removal of the film from the carrier. Examples of suitable carriers include plastic or polyester films, polypropylene, polycarbonate, non-siliconized polyethylene terephthalate film, non-siliconized Kraft paper, polyethylene impregnated Kraft paper, metal belts, voltage or corona treated belts, drum dryers, and polytetrafluroethylene-impregnated glass fabric. Multiple carriers may be employed to create a multi-layered film product.

It has been found that a particularly preferred method of casting the film on the carrier may be through use of a slot die extrusion. By use of multiple extruders and specially constructed dies, it is possible to add multiple color stripes or designs to the product. It is also possible to oscillate the die head to produce wavy lines on the product. The resulting films can be laminated to produce various visual effects.

The casting of the solution onto a suitable carrier material can be performed using any conventional coating technique. Examples of coating techniques include spraying, dipping, comma coaters, knife over plate, roll over roll, reverse roll, slot die extrusion, and various extrusion techniques. Film thickness can be controlled by adjusting the gap on the coating head, or by applying the desired amount of the solution onto the substrate/carrier.

It should be noted that no particular limitation is placed on the thickness of the film layer except that the resultant film must rapidly dissolve in the mouth of the consumer. Therefore the thickness of the film can be varied based on, for example, the desired speed of dissolution of the edible film while in the oral cavity. Not only can the thickness be varied but a multi-layered film product may be provided.

After the coating step, in an embodiment, the film passes through a dryer for moisture reduction. In the dryer, drying is carried out through a variety of different means, such as high velocity turbulent hot air, conduction from steam heated slide bed, direct heating or casting of film onto a heated drum or belt, hot or cold air impingement, infrared heating, or any other suitable drying equipment that does not adversely affect the components of the film.

While in the drying system, various treatments can be applied to the solution to create a novel edible thin film product. For example, the solution may be exposed to a brush, giving the film texture; the solution may be separated by an air knife, thereby creating wells or creases that may aid in making a “peel and pull” type of product; the wells created by the air knife may be filled with a different type of confectionary; the solution may be sprinkled with an ingredient to add texture, flavor, or any other type of oral sensation.

Once the film exits the drying system, the dried film can be either taken-up along with its substrate or peeled from the carrier to form a wide roll. As the film exits the drying system, it can be exposed to a number of different types of treatments. The film may be sprinkled with sugar, starch, flavor, color enhancers such as glitter, acids, bioadhesives, actives and texturizers such as candy sprinkles to make specialty edible thin film products directed to younger consumers.

As noted below, a wide variety of edible thin film products can be provided. The edible thin film can be a rolled edible thin film. Rolled edible thin films and methods of making same are disclosed in U.S. Ser. No. 10/228,742, entitled “Rolled Edible Thin Film Products and Methods of Making Same,” filed on Aug. 27, 2002, the disclosure of which is incorporated herein by reference. Of course, other methods of making edible thin films can be utilized.

The present invention provides, in an embodiment, specialty edible thin films. These specialty edible thin films can be produced at various points during the film making process. An advantage of the present invention is that it can provide concepts which appeal to younger consumers. Types of specialty edible thin film products include, but are not limited to, films that are multi-flavored, multi-layered, multi-colored, multi-shapes or forms, texturized, laminated, printed, graphical designs, produce “tongue-tattoos”, provide an oral sensation, have varying dissolution profiles, include bioadhesive components and combinations thereof. A variety of edible thin films are possible such as those disclosed in U.S. patent application Ser. No. ______, entitled “Edible Thin Film Products and Methods of Making Same” filed on ______, the disclosure of which is incorporated herein by reference.

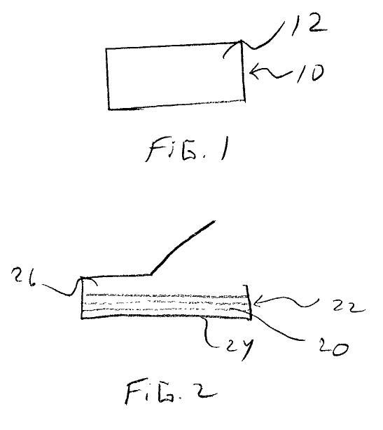

Referring now to the figures, FIG. 1 illustrates, generally, an edible thin film 10 of the present invention. As illustrated, the edible thin film 10 includes a body 12. As set forth in detail below, the body 12 can be constructed from a variety of components. The body 12 is designed to be placed in the mouth, specifically on the tongue of the user where it generally adheres thereto and dissolves. As noted above, a variety of edible thin film products are possible.

If desired, the body 12 can comprise at least two distinct regions that have a different color. The distinct regions can take a variety of forms. For example, the distinct regions can extend for the width of the film or only the depth of the film. It should be noted that the regions do not have to be symmetrical or the same size.

The distinct regions can provide different flavors to the consumer or the same flavor. For example, one region can be yellow and provide a lemon flavor and one region can be red and provide a cherry flavor. If desired, the distinct regions may have the same color but provide different flavors. For example, one region can provide a spearmint flavor while the other region provides a cinnamon flavor.

Furthermore, in an embodiment, the distinct regions can provide different oral sensations. For example, these sensations can comprise temperature (e.g., heat and cooling), gas release (e.g., a fizzing sensation) or moisture release. If desired, the entire edible thin film can provide the oral sensation or only portions thereof. Further, it is possible for the edible thin film to have distinct regions that provide different sensations depending on the region. Thus, one region of the film may provide a heating sensation while the other region provides a cooling sensation.

A surface of the edible film can include a design. This design can be any desired design. For example, the design can be indicative of the flavor of the edible film, e.g., a lemon for a lemon flavored film. Or the design may be a product or company indicator, e.g., the logo of the manufacturer. The design can be fanciful, seasonal, or regional, e.g., a local sports team logo. Or the design can depict a location, individual or cartoon character. Any design that can be placed on the surface of the film using a food grade ink, color, dye, or other ingestible media can be provided. In an embodiment, the design can be transferable to the tongue of the consumer. This can be used to create a tongue tattoo.

The edible thin film can include a body that has a cross-sectional shape that is not rectangular as in typical edible thin films such as Listerine® PocketPaks™. The body can have any of a variety of cross-sectional shapes including, by way of example and not limitation, triangular, oval, circular, and hexagonal shapes. On the other hand, the body can have a cross-sectional shape that is indicative of the flavor of the edible thin film, e.g., a lemon shape for a lemon flavored film. Of course, the shape of the body can be fanciful if desired or representative of any other object, person, character or any other design desired.

A multilayer edible thin film can also be provided. To this end, the edible thin film can include a top layer and bottom layer. The layers can be laminated or co-extruded onto each other. The layers can provide different properties to the edible thin film.

Referring now to FIG. 2, illustrated therein is an edible thin film 20 in a container 22. The container 22 is designed to house the edible thin film 20 so that it can be sold to consumers and dispensed therefrom. The body 24 of the container 22 defines an interior 26 for receiving and storing the edible thin film 20.

If desired, the edible thin film and container can be designed so that the film and container have a shape and/or color indicative of the flavor. For example, a lemon flavored film can be in the shape of a lemon and the body of the container in the shape of a lemon. On the other hand, a lemon flavored film can merely have a color indicative of its flavor, i.e., yellow. The container also can have portions thereof, or the entire container, of the same color, e.g., yellow. In such an embodiment, the container and/or edible thin film will suggest the flavor of the edible thin film due to one of its characteristics, e.g., color or shape.

Although FIG. 2 illustrates a specific edible thin film/container structure, a variety of containers can be used to house edible thin film of the present invention. Such designs would include, for example, containers allowing the edible thin film to be accessed through an opening in the container and pulled out as desired. The edible film may be housed in a single primary package, which is combined with a secondary package offering extra product protection, increased shelf life, or consumer appeal. Furthermore, the single primary package may be refillable and can be purchased separately from the secondary package. But, it should be noted that any container design can be used as long as it allows the consumer to access the edible thin film.

All of the above edible thin film concepts can either be used alone or in combination. Thus, a wide variety of edible thin films and products are possible.

The edible thin films of the present invention are also suitable for preparing products for food applications beyond direct consumption. For instance, they may be used to add flavors or other ingredients to soups, beverages and other consumer and commercially-prepared comestibles. For example, citrus flavor films can be provided that are added to water by a consumer to provide flavored water. A wide variety of flavors can be envisioned as well as food and beverages to which the flavored films can be added.

The edible thin film products can comprise a large number of suitable formulations. Any suitable water-soluble, film-former can be used to produce a rolled edible thin film product. Suitable film-formers include but are not limited to water-soluble non-starch polysaccharides such as carboxymethylcellulose (CMC), methylcellulose, hydroxypropylmethylcellulose (HPMC), guar gum, locust bean gum, agar gum, xanthan gum, carrageenan, tamarind, agar agan, konjac, arabinogalactan, larch arabinogalactan, beta-glucan, algins, propylene glycol, levan, elsinan, pullulan, gellan, curdlan, pectins, chitosan, and gum arabic; native starches such as corn starch, waxy maize starch, high-amylose corn starch, potato, tapioca, rice and wheat starch; modified starches such as those that have been acid modified, bleached, oxidized, esterified, etherified, crosslinked, and treated enzymatically; starch hydrolyzed products such as maltodextrin; protein such as albumen, gelatin, casein, salts of casein, whey, wheat gluten, zein, and protein derived from soybeans; polymers such as polyvinyl pyrrolidone, methycrylate copolymer, and carboxyvinyl copolymers alone or in any combination. In an embodiment, the concentration of the film-forming agent constitutes between 5% to about 60% by dry weight, or 20% to about 40% by dry weight of the final film composition.

Further, any suitable food-grade bulk filler can also be added to produce the film. Such fillers can reduce any slimy texture as well as provide structure to the film making it more palatable. In an embodiment, the filler can comprise approximately 1% to about 30% by dry weight of the film, or approximately 5% to about 15% by dry weight of the film. The filler can include microcrystalline cellulose, cellulose polymers, such as wood, magnesium and calcium carbonate, ground limestone, silicates, such as magnesium and aluminum silicate, clay, talc, titanium dioxide, mono-calcium phosphate, di-calcium phosphate, tri-calcium phosphate, other like bulk fillers or combinations thereof.

If it is desired to use lower levels of film forming agents, softeners can also be employed to ensure the flexibility of the film, thereby reducing brittleness and increase ease of manufacture. The softeners, which are also known as plasticizers, may include tallow, hydrogenated tallow, hydrogenated and partially hydrogenated vegetable oils, cocoa butter, sorbitol and other polyols, glycerin, palarinit, polyethylene glycol, propylene glycol, invert sugars, corn syrup, lecithin, hydrogenated lecithin, enzyme-modified lecithin, mono-, di- and triglycerides, acetylated monoglycerides, MCTs such as neobee oil, fatty acids (e.g. stearic, palmitic, oleic, and linoleic acids), and combinations thereof. In an embodiment, the softener can constitute 0% to about 20% by dry weight of the film, or approximately 2% to about 10% by dry weight of the film.

Another means of controlling the brittleness of the film is to maintain an adequate moisture level in the film. Preferably, moisture levels should range from approximately 1% to about 20%, or approximately 5% to about 10% of the final film product.

A variety of other suitable ingredients can be added to the edible thin film of the present invention. For example, any suitable medicament for oral cleansing, breath freshening or the like can be added to the film formulation. The medicaments can include, for example, pH control agents, such as urea and buffers; inorganic components for tartar and caries control, such as phosphates, pyrophosphates, polyphosphates, and fluorides; whitening agents, enzymes such as proteolytic and glycolydic enzymes to disrupt plaque and the pellicle, enzymes such as oxidoreductase to oxidize stains on teeth and enzymes which react with sulfur compounds in breath, (such enzymes are produced by Genencor, Enzyme Development Corporation, Valley Research and Novozymes); breath freshening agents such as food acceptable metal salts such as zinc lactate, copper or zinc gluconate; anti-plaque/anti-gingivitis agents, such as chlorohexidene, CPC, and triclosan; saliva stimulating agents including, for example, food acids such as citric, lactic, malic, succinic, ascorbic, adipic, fumaric, and tartaric acids; pharmaceutical agents, nutraceutical agents, energizing ingredients, vitamins, mineral, other like medicaments or combinations thereof. Specific vitamins and minerals which are especially suited to delivery by orally-consumed films include vitamins B12, B1, B2, B6, A, D, E, folic acid, selenium, iron, and zinc.

The medicaments can be delivered or released into the oral cavity for an effective oral treatment, such oral cleansing and/or breath freshening. In this regard, the film forming agents of the edible film composition can act to entrap the medicaments within the oral cavity thereby providing extended efficacy thereof. The film product may be multilayered, having at least one layer with an active ingredient, and at least one layer free of any active agents. Further, medicaments having bitter notes may have their bitterness masked through different methods, particularly via microencapsulation.

If desired, the edible thin film formulations of the present invention can also include colorants or coloring agents which can be used in any suitable amount to produce a desired color. Further, the edible thin films of the present invention may have colored stripes and/or other related designs or shapes to produce color contrasts on the edible rolled film. Additional coloring may be used to intentionally dye the tongue of the consumer. Coloring agents can include, for example, natural food colors and dyes suitable for food, drug, and cosmetic applications. The colorants are typically known as FD&C dyes and lakes.

A variety of flavoring agents can also be added to the rolled edible thin films. Any suitable amount and type of artificial and/or natural flavoring agents can be used in any sensorially acceptable fashion. For example, the flavor can constitute about 0.1% to about 20% by dry weight of the film, preferably approximately 10% to about 15%. The flavoring agent can include, for example, essential oils, spice, synthetic flavors or mixtures including but not limited to oils derived from plants and fruits such as citrus oil, fruit essences, peppermint oil, spearmint oil, other mint oils, clove oils, oil of wintergreen, anise and the like, flavor oils with germ killing properties such as menthol, eucalyptol, thymol, like flavoring agents or combinations thereof.

The flavor can be enhanced and distributed evenly throughout the product by emulsification. Any suitable amount and type of natural and/or synthetic food-grade emulsifier can be used. For example, the emulsifier can include lecithin, enzyme-modified lecithin, food-grade non-ionic emulsifiers, such as fatty acids (C₁₀-C₁₈), mono and diacyl glycerides, ox bile extract, polyglycerol esters, polyethylene sorbitan esters, propylene glycol, sorbitan monopalmitate, sorbitan tristerate, other like emulsifiers or combinations thereof.

The flavors can be emulsified by any suitable emulsification process, such as mechanical processing, vigorous stirring, intense pressure fluctuations that occur in turbulent flow such as homogenization, sonification, colloid milling and the like. Further, the flavors may also be encapsulated or spray dried, and incorporated into the film coating syrup or onto the edible film product to enhance flavor properties or to add texture to the film composition.

Sweetening agents may also be used in the edible film products of the present invention. Sugar sweeteners generally include saccharide-containing components including, but not limited to, sucrose, dextrose, maltose, dextrin, invert sugar, fructose, levulose, galactose, corn syrup solids, and the like, alone or in any combination. Sugarless sweeteners include, but are not limited to, sugar alcohols such as sorbitol, mannitol, xylitol, isomalt, hydrogenated starch hydrolysates, maltitol, and the like, alone or in any combination. However, the low weight of the film products of the present invention generally render these low intensity sweeteners ineffective for purposes of sweetening although they may provide functional benefits. Any suitable amount of sweetening agent can be used.

High intensity artificial sweeteners may preferably be used, alone or in combination with the above. Preferred sweeteners include, but are not limited to, sucralose, aspartame, N-substituted APM derivatives such as neotame, salts of acesulfame, alitame, saccharin and its salts, cyclamic acid and its salts, glycyrrhizin, dihydrochalones, thaumatin, monellin, and the like, alone or in any combination. In order to provide enhanced or delayed sweetness, or to provide texture to the rolled film product, it may be desirable to encapsulate the sweetener. Such techniques as wet granulation, wax granulation, spray drying, spray chilling, fluid bed coating, coacervation, and fiber extension may be used to achieve the desired characteristics.

Combinations of sugar and/or sugarless sweeteners may be used in the film product. Additionally, a softening agent may also provide additional sweetness such as with aqueous sugar or alditol solutions.

Cooling agents may also be employed in the present invention, cooling agents include, but are not limited to, menthol, WS3, WS23, Ultracool, monomenthyl succinate, alone or in any combination. Again, these cooling agents may be encapsulated or spray dried onto the film or incorporated into the coated syrup to enhance a variety of oral sensations.

Depending on the ingredients being used to make the edible thin film product, preservatives may also be employed to ensure the safety and quality of the edible thin film. Suitable preservatives include, but are not limited to, sorbic acid, sodium benzoate, potassium sorbate, methyl p-hydroxybenzoate, methyl paraben, propyl paraben, sodium propionate, and propyl p-hydroxybenzoate alone or in any combination. In addition, suitable antioxidants can also be utilized.

It should be appreciated that any suitable type, number and arrangement of process procedures or steps (e.g. mixing, heating, drying, cooling, addition of ingredients), process parameters (e.g. temperature, pressure, pH, process times) or the like can be utilized to practice the present invention.

By way of example and not limitation, the following examples illustrate various embodiments of edible thin film formulations of the present invention.

### EXAMPLES

(% Dry Weight)

| Ingredient | Ex. 1 | Ex. 2 | Ex. 3 | Ex. 4 | Ex. 5 | Ex. 6 |
|---|---|---|---|---|---|---|
| Hydroxypropylated Starch | — | 34.85 | — | 20.0 | — | — |
| Maltodextrin | — | — | 26.0 | 17.0 | — | 18.0 |
| Pullulan | 28.0 | — | — | 16.0 | 50.0 | — |
| Microcrystalline Cellulose | 5.5 | 10.0 | 7.5 | — | 4.5 | 15.0 |
| Carrageenan | 14.0 | 10.0 | 8.0 | 5.0 | — | 16.0 |
| Glycerin | — | 10.0 | — | 3.0 | 9.5 | 6.0 |
| Propylene Glycol | 9.0 | — | 6.0 | 3.0 | — | — |
| Sodium Alginate | 14.0 | 8.0 | 23.0 | 7.0 | — | 25.5 |
| Lecithin | — | — | 1.0 | — | — | — |
| Sucralose | 1.0 | 2.0 | 0.50 | — | 0.50 | — |
| Neotame | — | — | — | — | 1.0 | 0.45 |
| Aspartame | 0.4 | — | 1.5 | 1.0 | 0.50 | 1.0 |
| Wintergreen Flavor | — | — | — | 10.0 | — | — |
| Spearmint | — | — | 14.0 | — | — | 10.0 |
| Menthol | — | — | — | 4.9 | 6.3 | 2.0 |
| Cherry Flavor | 12.0 | — | — | — | 8.0 | — |
| Lemon Flavor | 2.0 | 15.0 | 2.0 | — | 4.5 | — |
| Citric Acid | 1.0 | — | — | — | 0.50 | — |
| WS-3 | 2.0 | — | 0.50 | 1.0 | 1.5 | — |
| Color | 0.0 | 0.15 | 0.25 | 0.10 | 0.20 | 0.05 |
| Water | 10.95 | 10.0 | 9.75 | 12.0 | 13.0 | 6.0 |
| TOTAL | 100.0 | 100.0 | 100.0 | 100.0 | 100.0 | 100.0 |
| Ingredient | Ex. 7 | Ex. 8 | Ex. 9 | Ex. 10 | Ex. 11 | Ex. 12 |
| Maltodextrin | 23.0 | — | — | — | 30.0 | — |
| PURE-COTE ® B790* | — | — | 46.0 | — | — | — |
| Acid Thinned Corn Starch | — | — | — | 32.0 | — | 20.0 |
| Levan | — | 21.0 | — | 10.0 | — | — |
| Alginate | 26.0 | 17.0 | — | 5.0 | — | 3.5 |
| Carrageenan | 5.0 | 14.0 | 11.0 | — | 6.0 | 2.5 |
| Gelatin | — | 5.0 | — | — | — | 23.0 |
| Polyvinyl Pyrollidone | — | — | — | 8.0 | — | 15.0 |
| Microcrystalline Cellulose | 8.0 | 3.0 | — | — | 6.0 | 1.2 |
| Silica | — | — | 5.0 | — | — | — |
| Calcium Phosphate | — | — | — | — | 10.25 | 5.3 |
| Glycerin | — | — | — | 6.5 | 2.0 | 1.5 |
| Locust Bean Gum | — | — | 7.5 | — | — | 3.0 |
| Soybean Oil | 16.0 | — | — | 2.0 | 6.0 | — |
| Vegetable Oil | — | 10.0 | — | — | 6.0 | — |
| Lecithin | 0.50 | — | 1.0 | 2.0 | — | 0.20 |
| Sorbitol | — | — | 4.5 | — | — | 2.0 |
| Corn Syrup | — | — | | 4.5 | — | — |
| Dextrose | — | — | — | 8.0 | — | 1.0 |
| Neotame | — | — | — | 1.0 | — | 0.25 |
| Saccharin | — | 3.0 | — | — | — | — |
| Sucralose | — | — | 1.50 | — | 3.0 | — |
| Menthol | 5.0 | — | 3.0 | 1.0 | — | — |
| Peppermint | 8.0 | — | — | — | — | — |
| Cinnamon | — | — | — | 10.0 | — | — |
| Anise | — | — | 9.0 | — | — | — |
| Eucalyptol | 1.0 | 3.0 | 0.50 | — | — | — |
| Methyl Salicylate | — | 12.75 | 1.0 | — | — | — |
| Grape Flavor | — | — | — | — | 13.0 | — |
| Melon Flavor | — | — | — | — | — | 11.0 |
| WS-23 | — | 2.0 | — | 0.50 | — | — |
| Ultracool | — | — | 0.50 | 0.50 | — | — |
| Adipic Acid | — | — | — | — | 2.50 | — |
| Color | 0.30 | 0.25 | 0.50 | — | 0.35 | 0.55 |
| Water | 7.20 | 10.0 | 8.50 | 9.0 | 14.9 | 10.0 |
| TOTAL | 100.0 | 100.0 | 100.0 | 100.0 | 100.0 | 100.0 |
| Ingredient | Ex. 13 | Ex. 14 | Ex. 15 | Ex. 16 | Ex. 17 | Ex. 18 |
| Hydroxypropylmethylcellulose (HPMC) | 27.0 | 15.0 | — | — | — | — |
| PURE-COTE ® B792* | — | — | — | 48.0 | 21.0 | — |
| Gum Arabic | — | 25.0 | 5.0 | — | — | — |
| Pectin | 12.0 | — | 23.0 | — | — | — |
| Chitosan | — | 5.0 | — | — | 30.0 | — |
| Oxidized Potato Starch | — | — | 5.5 | — | — | 25.0 |
| Waxy Maize Starch | — | 11.5 | 2.5 | — | — | — |
| Alginate | — | — | — | 22.0 | 6.0 | — |
| Casein | — | — | 3.0 | — | — | 25.0 |
| Wheat Gluten | — | — | 8.0 | — | 2.0 | — |
| Carboxyvinyl Copolymer | 15.0 | — | — | — | — | — |
| Aluminum Silicate | — | 7.0 | — | — | 12.0 | — |
| Calcium Carbonate | 5.0 | — | 15.0 | — | — | 4.5 |
| Titanium Dioxide | — | 2.50 | — | — | — | 4.5 |
| Hydrogenated Lecithin | — | — | — | 2.0 | — | — |
| Cocoa Butter | 15.0 | — | — | — | 3.5 | 1.5 |
| Linoleic Acid | — | 2.0 | 5.5 | — | 4.5 | — |
| Orange Mint Flavor | 15.0 | — | | — | 4.0 | — |
| Wild Berry Flavor | — | 10.50 | — | — | 5.0 | — |
| Strawberry Flavor | — | — | — | — | — | 12.25 |
| Clove Oil | — | — | 2.0 | — | — | — |
| Pepper | — | — | 0.40 | — | — | — |
| Peppermint | — | — | — | 9.15 | — | — |
| Eucalyptol | — | — | — | 1.0 | — | — |
| Cardamom | — | — | 8.0 | — | — | — |
| Sorbitan Monopalmitate | 1.0 | — | — | — | — | — |
| Citric Acid | — | — | — | — | — | 6.0 |
| Xylitol | 2.0 | — | 1.0 | — | — | — |
| Malitol | — | — | 3.25 | — | 0.5 | — |
| Fructose | — | — | 2.0 | — | — | 5.0 |
| Glycyrrhizin | — | 1.0 | — | — | 0.5 | — |
| Acesulfame K | — | 1.25 | 0.25 | — | — | — |
| Encapsulated Aspartame | 0.50 | — | — | 1.25 | — | — |
| Liquid Sorbitol | 1.0 | 3.25 | — | 7.0 | — | 2.0 |
| Monomethyl Succinate | — | 0.50 | — | — | — | 1.0 |
| BHT | — | 1.0 | — | — | — | 0.25 |
| Color | 0.50 | 1.0 | 0.50 | 0.35 | 0.25 | 0.15 |
| Water | 6.0 | 13.5 | 15.1 | 9.25 | 10.75 | 12.85 |
| TOTAL | 100.0 | 100.0 | 100.0 | 100.0 | 100.0 | 100.0 |
| Ingredient | Ex. 19 | Ex. 20 | Ex. 21 | Ex. 22 | Ex. 23 | Ex. 24 |
| Maltodextrin | 45.0 | — | — | 22.0 | — | 18.0 |
| Pullulan | — | 26.0 | — | — | — | 15.0 |
| Alginate | 2.0 | — | 29.5 | — | — | — |
| Carrageenan | — | — | 18.0 | — | 55.0 | — |
| High Amylose Corn Starch | 10.0 | 6.5 | — | 8.0 | — | — |
| Whey Protein | — | — | 9.0 | — | — | 3.0 |
| Zein | — | 19.0 | — | 20.0 | — | 27.5 |
| Methylcrylate Copolymer | — | 14.0 | — | 10.0 | — | 1.5 |
| Microcrystalline Cellulose | 7.0 | — | — | — | 17.0 | — |
| Magnesium Silicate | 4.0 | — | — | — | — | — |
| Tri-Calcium Phosphate | 4.0 | — | — | — | — | — |
| Hydrogenated Tallow | 3.0 | — | — | — | — | — |
| Sucralose | — | — | — | 1.5 | 1.0 | 3.0 |
| Encapsulated Aspartame | — | — | — | — | 1.0 | — |
| Neotame | 2.5 | 3.0 | 1.0 | — | — | — |
| Sorbitol | 1.50 | — | — | 1.0 | — | — |
| Maltose | — | 4.5 | — | 2.5 | — | — |
| WS-3 | — | 2.9 | — | 1.0 | — | 4.0 |
| Menthol | 8.0 | 2.0 | — | 2.0 | — | — |
| Rose Oil | — | 2.0 | — | — | — | — |
| Honey Lemon Flavor | — | — | — | 6.0 | — | — |
| Tangerine Flavor | — | — | — | 5.0 | — | 15.0 |
| Lime Flavor | — | — | — | — | 12.0 | — |
| Methyl Salicylate | — | — | 10.0 | — | — | — |
| Eucalyptol | 2.0 | 7.5 | 4.95 | — | — | — |
| Tea Tree Oil | — | — | 10.0 | — | — | — |
| Grapeseed Extract | — | 3.0 | — | — | — | — |
| Vitamin C | — | — | — | 2.5 | — | — |
| Vitamin A, B, D, E Complex | — | — | 3.5 | — | — | — |
| Zinc Gluconate | — | — | — | 5.5 | — | — |
| Sodium Selenite | — | — | — | — | 0.15 | — |
| Encapsulated Reduced Iron | — | — | — | — | 2.0 | — |
| Malic Acid | — | — | — | 3.5 | — | 0.50 |
| Echinacea | — | — | 1.0 | — | — | — |
| Cetyl Pyridinium Chloride | 3.0 | — | — | — | — | — |
| Encapsulated Caffeine | — | 3.0 | — | — | — | — |
| Sodium Benzoate | — | — | 0.5 | — | — | — |
| BHA | — | — | 1.0 | — | — | 0.30 |
| Color | — | 0.1 | 0.55 | 0.45 | 0.30 | 0.20 |
| Water | 8.0 | 6.5 | 11.0 | 9.05 | 11.55 | 7.0 |
| TOTAL | 100.0 | 100.0 | 100.0 | 100.0 | 100.0 | 100.0 |

*PURE-COTE ® B790 is a product of the Grain Processing Corporation (GPC), located in Muscatine, Iowa. PURE-COTE ® B790 is a flash-dried modified corn starch designed specifically for applications with very low viscosity.
*PURE-COTE ® B792 is a product of the Grain Processing Corporation (GPC), located in Muscatine, Iowa. PURE-COTE ® B792 is a pregelatinized modified corn starch designed specifically for applications requiring low viscosity.

In the above examples as well as the examples set forth below, the method of making the edible thin film is generally as set forth in the section entitled preparation method set forth infra.

Using any of the above formulas for Examples 25-28, further examples include:

### Example 25

Upon exiting the drying system, powdered citric acid is dispersed evenly upon the dried film layer.

### Example 26

Flavor crystals are sprinkled onto the coating solution while in the drying chamber.

### Example 27

While exiting the drying system, the dried film layer is stamped, leaving the imprint of a company logo.

### Example 28

1.5% proteolytic enzyme is added to the film formula.

### Example 29

Examples 1, 2, and 12 are employed to make a multi-flavored, multi-layered and multi-colored edible film product.

### Example 30

Examples 7, 8, and 19 are employed to make a multi-flavored and multi-layered edible film product that offers a dental benefit.

### Example 31

Example 30 is employed, wherein one film layer has a thickness of 10 microns, one film layer has a thickness of 30 microns, and one film layer has a thickness of 60 microns.

### Example 32

The coating solution of any of the above formulations is released through multiple die heads in which each die head contains the same coating formulation but has different coloring added. As the different colored solutions are released onto a moving substrate, a comb-like separator inhibits the mixing of the solutions to yield a striped edible film product.

### Example 33

Using Example 32, the solution is dried to the moving substrate and the dried film is packaged with the substrate to create a “peel and pull” edible film product.

### Example 34

Using Example 2, upon exiting the drying system, die cutting is employed to make a lemon-shaped yellow edible film product.

### Example 35

Using Example 20, while moving through the drying system, die cutting is employed to make a coffee-cup shaped toffee-colored edible film product.

### Example 36

As the coating solution of any of the above formulations is released onto the substrate, the roller employed has ridges on it to create a textured, rippled effect on the edible film product.

### Example 37

Using Example 34, the product is packaged in a container having a body that is lemon shaped.

### Example 38

Using Example 31, one film layer is modified so that it substantially adheres to the oral mucosa of the consumer.

### Example 39

The edible film product of any of the above formulations is modified so that it substantially adheres to the tooth of a consumer.

### Example 40

Using Example 23, the film is marketed so that a consumer is encouraged to dissolve the film in a beverage to add flavor to a beverage.

Preparation Method:

1) Blending:

a) Powdered materials (such as film-forming agents) are blended together using a ribbon blender or equivalent.

b) Flavors and flavor components/enhancers are blended together using mechanical agitation or equivalent.

2) Mixing:

a) Add powdered mix to a mixing tank filled with the appropriate amount of water.

b) After the powdered mix is mostly hydrated, increase the temperature and add softening agents, color, and sweetener in succession while the solution temperature is raising. Maintain the blend at an even temperature, about 105-115° F.

c) The conditions of the mixing room are about 70-80° F., 40-50% RH.

3) Drying:

a) Feed the solution into a feed hopper.

b) Upon entering the drying system, the film is perforated along lines generally perpendicular to the leading edge of the sheet using a comb or bar.

c) Adjust heater temperature to achieve an exit film temperature of about 215-220° F. This should produce a film having a moisture of about 9-11%.

d) Adjust coma roll to produce a dry thickness of about 48-52 microns.

e) Drying room conditions are about 70-80° F., 40-50% RH.

4) Separating:

a) The take-up roll is then broken down into narrower rolls along the score lines created while in the drying system.

b) The film roll is then unwound from the substrate and packaged as desired.

By way of example and not limitation, the following examples illustrate various embodiments of the rolled edible thin film formulations of the present invention.

### EXAMPLES

(% Finished Wt.)

| Ingredient | Ex. 41 | Ex. 42 | Ex. 43 | Ex. 44 | Ex. 45 | Ex. 46 |
|---|---|---|---|---|---|---|
| Corn Starch | 25.0 | — | — | 30.0 | — | — |
| Hydroxypropylated Starch | — | — | — | — | — | 47.35 |
| Carrageenan | 14.0 | 12.0 | 10.0 | — | 9.0 | — |
| Glycerin | 10.0 | 8.0 | — | 5.0 | 9.0 | 7.50 |
| Gelatin | — | — | 12.0 | 5.0 | — | 2.50 |
| Microcrystalline Cellulose | 3.0 | 7.0 | — | 5.0 | 8.0 | — |
| Sodium Alginate | — | 25.0 | 10.0 | 5.0 | 30.0 | 22.0 |
| Maltodextrin | — | 20.5 | — | — | 18.0 | — |
| Pullulan | 6.0 | — | 40.0 | — | — | — |
| Sorbitol | 15.0 | — | — | 5.0 | — | — |
| Liquid Sorbitol | — | — | — | 10.0 | — | — |
| Acesulfame K | — | — | — | — | — | 1.0 |
| Sucralose | — | 1.4 | 1.0 | 1.0 | — | 1.25 |
| Aspartame | 1.5 | — | 2.0 | — | 2.0 | — |
| WS-3 | — | 1.5 | — | 1.0 | — | — |
| WS-23 | — | — | 2.0 | — | — | — |
| Menthol | — | 6.0 | 1.0 | — | 3.0 | 1.0 |
| Spearmint | — | — | — | — | 6.0 | — |
| Cherry Flavor | 15.0 | 5.0 | — | 12.0 | — | — |
| Peppermint | — | — | — | — | 6.0 | — |
| Eucalyptol | — | — | — | — | — | 6.00 |
| Methyl Salicylate | — | 5.0 | 10.0 | — | — | — |
| Citric Acid | — | — | — | 5.0 | 1.0 | — |
| Adipic Acid | — | — | — | — | — | 1.00 |
| Color | 0.5 | 0.5 | — | 0.50 | 0.35 | 0.40 |
| Water | 10.0 | 8.0 | 12.0 | 15.5 | 7.65 | 10.0 |
| Total | 100.0 | 100.0 | 100.0 | 100.0 | 100.0 | 100.0 |
| Ingredient | Ex. 47 | Ex. 48 | Ex. 49 | Ex. 50 | Ex. 51 | Ex. 52 |
| Hydroxyethylated Starch | — | 48.0 | — | — | — | — |
| PURE-COTE ® B790* | 50.0 | — | — | — | — | — |
| Enzyme Hydrolyzed Corn Starch | — | — | 22.0 | — | — | — |
| Maltodextrin | — | — | 5.0 | 28.0 | — | — |
| Casein | — | 2.9 | — | — | 3.5 | — |
| Pullulan | — | — | 20.0 | — | — | 35.0 |
| Polyvinyl Pyrollidone | — | 11.0 | — | — | 6.0 | — |
| Hydroxypropylmethylcellulose | — | — | — | — | 30.0 | — |
| Xanthan Gum | — | — | — | — | — | 6.0 |
| Locust Bean Gum | — | — | — | — | — | 8.0 |
| Glycerin | — | — | — | 12.0 | 9.5 | 10.5 |
| Polyethylene Glycol | — | — | — | — | 6.0 | — |
| Propylene Glycol | 1.50 | — | 10.0 | — | 6.0 | — |
| Carrageenan | — | 11.0 | — | 10.0 | — | 25.0 |
| Sodium Alginate | — | — | — | 13.75 | — | — |
| Calcium Alginate | 22.9 | — | — | — | — | — |
| Silica | — | — | — | 5.0 | — | — |
| Calcium Carbonate | — | — | 3.0 | — | — | — |
| Pectin | 4.0 | — | — | — | — | — |
| Lecithin | — | 2.0 | 1.0 | 1.5 | — | — |
| Saccharin | — | — | — | — | — | 2.0 |
| Aspartame | 0.25 | — | — | 1.0 | 1.5 | — |
| Sucralose | 1.25 | — | — | — | — | — |
| Neotame | — | — | 0.50 | — | 1.5 | — |
| Encapsulated Acesulfame K | — | — | 1.5 | — | 1.0 | — |
| Corn Syrup | — | — | 15.0 | — | — | — |
| Guar Gum | — | 2.0 | — | — | — | — |
| Sorbitan Monopalmitate | — | — | — | — | 4.0 | — |
| Ultracool | — | — | — | 1.5 | — | 5.0 |
| Citric Acid | — | — | — | 1.5 | — | — |
| Adipic Acid | — | — | — | 1.5 | — | — |
| Methyl Salicylate | — | — | — | — | — | 1.5 |
| Eucalyptol | — | 6.0 | — | — | — | 0.5 |
| Thymol | — | — | 3.0 | — | — | 0.5 |
| Encapsulated Peppermint | — | — | — | — | 12.0 | — |
| Menthol | — | — | 8.0 | — | 4.0 | 1.5 |
| Lemon Flavor | 11.0 | — | — | 8.0 | — | — |
| Mixed Berry Flavor | — | 5.0 | — | 8.0 | — | — |
| Color | 0.05 | 0.10 | 0.50 | 0.25 | — | 0.5 |
| Water | 9.05 | 12.0 | 10.5 | 8.0 | 15.0 | 4.0 |
| Total | 100.0 | 100.0 | 100.0 | 100.0 | 100.0 | 100.0 |

| Ingredient | Ex. 53 | Ex. 54 | Ex. 55 | Ex. 56 | Ex. 57 | Ex. 58 | Ex. 59 | Ex. 60 |
|---|---|---|---|---|---|---|---|---|
| Hydroxypropylcellulose | 45.0 | — | — | — | — | — | 18.0 | — |
| Waxy Maize Starch | — | 26.0 | — | — | — | — | 15.0 | — |
| Potato Starch | 2.0 | — | 29.5 | — | — | — | — | — |
| Pullulan | — | — | 8.0 | — | 55.0 | — | — | — |
| Microcrystalline Cellulose | — | — | 10.0 | 6.5 | — | 8.0 | — | 6.5 |
| Sucrose Fatty Acid Ester | — | — | 1.0 | — | — | — | 3.0 | — |
| Maltodextrin | — | 19.0 | — | 20.0 | — | 28.0 | — | 19.0 |
| Carrageenan | — | 16.0 | — | 10.0 | — | 8.0 | 1.5 | 10.0 |
| Gelatin | 7.0 | — | — | — | 2.0 | — | — | — |
| Polyvinyl Alcohol | 6.0 | — | — | — | — | — | — | — |
| Sodium Polyacrylate | 5.0 | — | — | — | — | — | — | — |
| Carboxymethylcellulose | 5.0 | — | — | — | — | — | — | — |
| Xanthan Gum | — | 3.0 | — | — | — | — | — | — |
| Karaya Gum | 3.5 | — | — | — | 6.0 | — | — | — |
| Glycerin | — | — | — | 6.0 | — | 4.5 | — | 6.0 |
| Titanium Dioxide | — | — | 2.0 | — | — | — | 2.5 | — |
| Sodium Alginate | — | — | — | 25.0 | 2.0 | 27.0 | 13.0 | 19.0 |
| Sorbitol | — | — | 1.5 | — | — | 0.05 | — | — |
| Encapsulated Aspartame | — | — | — | — | — | — | 1.0 | — |
| Sucralose | — | — | — | — | — | 1.5 | 1.0 | 3.0 |
| Corn Syrup | — | — | 1.0 | — | — | — | — | — |
| Soybean Oil | — | — | 15.4 | — | — | — | — | — |
| Lecithin | — | — | — | 1.5 | 0.5 | 0.50 | — | 1.5 |
| Dextrose | — | — | 2.0 | — | — | — | — | — |
| Fructose | — | 10.0 | — | — | 5.0 | — | — | — |
| WS-3 | — | 2.9 | — | 1.0 | — | — | 4.0 | 0.5 |
| Clove Oil | — | — | 1.0 | — | 4.5 | — | — | — |
| Menthol | 8.0 | 2.0 | — | 2.0 | — | — | 1.0 | 0.5 |
| Grape Flavor | — | — | — | — | — | — | 12.0 | 5.0 |
| Lemon Flavor | — | — | — | — | — | 5.0 | — | — |
| Rose Oil | — | 2.0 | — | — | — | — | 1.0 | — |
| Pepper | — | 2.0 | — | — | — | — | — | — |
| Orange Flavor | — | — | 3.0 | — | — | 4.0 | 2.0 | — |
| Peppermint Oil | — | — | — | 10.0 | 5.0 | 2.0 | — | — |
| Cardamom | 8.0 | 2.0 | — | — | — | 1.0 | — | — |
| Grapeseed Extract | — | — | — | 5.2 | 2.5 | — | — | — |
| Tea Catechins | — | — | — | — | — | 1.0 | — | — |
| Vitamin C | — | — | 3.0 | — | 2.5 | — | 5.0 | 9.9 |
| Vitamin A, B, D, E Complex | — | — | — | — | — | — | — | 5.0 |
| Zinc Gluconate | — | — | — | — | — | — | 5.0 | 1.0 |
| Sodium Selenite | — | — | — | — | — | — | — | 0.001 |
| Encapsulated Reduced Iron | — | — | — | — | — | — | — | 3.0 |
| Citric Acid | — | — | 2.0 | — | — | — | 5.0 | — |
| Echinacea | — | — | 3.0 | — | 2.5 | 1.0 | — | — |
| Cetyl Pyridinium Chloride | 3.0 | — | — | — | — | — | — | — |
| Encapsulated Caffeine | — | 5.0 | — | — | — | — | — | — |
| Sodium Benzonate | — | — | — | 2.0 | 0.5 | — | — | — |
| BHA | — | — | — | 0.5 | — | 0.05 | — | — |
| Color | 0.5 | 0.1 | 0.6 | 0.30 | 0.5 | 0.80 | 0.1 | 0.1 |
| Water | 7.0 | 10.0 | 17.0 | 10.0 | 11.5 | 7.6 | 9.9 | 9.999 |
| Total | 100.0 | 100.0 | 100.0 | 100.0 | 100.0 | 100.0 | 100.0 | 100.0 |

*PURE-COTE ® B790 is a product of the Grain Processing Corporation (GPC), located in Muscatine, Iowa. PURE-COTE ® B790 is a flash-dried modified corn starch designed specifically for applications requiring very low viscosity.

Preparation Methods:

1) Blending:

a) Powdered materials (such as film-forming agents) are blended together using a ribbon blender or similar type device.

b) Flavors and flavor components/enhancers are blended together using mechanical agitation or other means.

2) Mixing:

a) The powdered mix is added to a mixing tank filled with the appropriate amount of water.

b) After the powdered mix is mostly hydrated, the temperature is increased and softening agents, color, and sweetener are added in succession while the solution temperature is raising. The blend is maintained at an even temperature, about 105-115° F.

c) The conditions of the mixing room are about 70-80° F. and 40-50% RH.

3) Drying:

a) The solution is fed into a feed hopper.

b) Upon entering the drying system, the film is perforated along lines generally perpendicular to the leading edge of the sheet using a comb or bar.

c) The heater temperature is adjusted to achieve an exit film temperature of about 215-220° F. This should produce a film having a moisture of about 9-11%.

d) The coma roll is adjusted to produce a dry thickness of about 48-52 microns.

e) Drying room conditions are about 70-80° F. and 40-50% RH.

4) Separating:

a) The take-up roll is then broken down into narrower rolls along the score lines created while in the drying system.

b) The resultant edible thin film roll is then unwound from the substrate and packaged as desired.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A method for marketing confectionery products comprising the steps of:
selecting a brand name for a confectionery product; and
using the brand name on at least three different forms of confectionery products or cosmetic compositions.

2. The method of claim 1 wherein the forms of confectionery products are chosen from the group consisting of chewing gum, pressed tablets, edible thin film, and candy.

3. The method of claim 1 wherein the forms of cosmetic compositions are chosen from the group selected from toothpaste, mouth spray, mouthwash, and dental floss.

4. The method of claim 1 wherein the brand name is used for a period of time with a first of the three forms before it is used with a second or third of the three forms.

5. The method of claim 1 wherein the brand name is used for a period of time with a first and a second of the three forms before it is used with a third of the three forms.

6. The method of claim 1 wherein the brand name is used simultaneously with all three of the forms.

7. The method of claim 1 wherein the brand name is used in the same font on all three different forms of confectionery products.

8. A method of marketing products comprising the steps of:
selling a chewing gum product;
selling a pressed tablet product;
selling an edible thin film product; and
wherein each of the chewing gum, pressed tablet, and edible thin film are sold with a common brand name as well as a common distributor's name.

9. The method of claim 8 including the step of selling a cosmetic composition with the common brand name.

10. The method of claim 8 including the step of selling a toothpaste with the common brand name.

11. The method of claim 8 wherein the edible thin film provides breath freshening properties.

12. The method of claim 8 including the step of selling a candy with the common brand name.

13. The method of claim 8 wherein the chewing gum product is sold with the common brand prior to the sale of the pressed tablet product and edible thin film.

14. The method of marketing products of claim 8 wherein only one flavor of chewing gum is sold under the common brand name.

15. The method of marketing products of claim 8 wherein only one flavor of pressed tablet is sold under the common brand name.

16. The method of claim 8 wherein more than one flavor of chewing gum is sold under the common brand name.

17. The method of claim 8 wherein more than one flavor of pressed tablet is sold under the common brand name.

18. A method of marketing edible thin film products comprising the steps of selling edible thin film products that have a plurality of different geometric cross-sectional shapes.

19. The method of claim 18 wherein the edible thin film products having different geometric cross-sectional shapes are packaged separately.

20. The method of claim 18 wherein the geometric cross-sectional shapes are chosen from the group consisting of a rectangle, circle, triangle, hexagon, and oval.

21. The method of claim 18 wherein edible thin films having a different geometric cross-sectional shape have a different color.

22. The method of claim 18 wherein the geometric cross-sectional shape of the edible thin film is suggestive of a flavor of the edible thin film.

23. A method of generating revenues comprising the steps of marketing a line of edible thin films that includes edible thin films that vary in at least color and flavor.

24. The method of claim 23 wherein the edible thin film products that vary in color and flavor are packaged separately.

25. The method of claim 23 wherein the color of the edible thin film is suggestive of the flavor of the edible thin film.

26. A method of generating revenues comprising the steps of:
manufacturing an edible thin film that has a color that is suggestive of the flavor of the edible film when it is ingested; and
selling the edible film to a consumer.

27. The method of claim 26 wherein the flavor is chosen from the group consisting of lemon, orange, cherry, grape, and lime.

28. The method of claim 26 wherein the color is chosen from the group consisting of yellow, orange, red, purple, and green.

29. The method of claim 26 wherein edible thin films having a different flavor are packaged together.

30. The method of claim 26 wherein the edible thin film has breath freshening properties.

31. A method of marketing edible thin films comprising the steps of:
manufacturing edible thin films that are designed to be sold during a specific season due to a shape, design, or coloration of the edible thin film.

32. The method of claim 31 wherein the season is chosen from the group consisting of Christmas, Halloween, Valentine's Day, and Thanksgiving.

33. A method of marketing edible thin films comprising the step of providing edible thin films that include a design that is indicative of a region wherein the edible thin film is designed to be distributed.

34. The method of claim 33 wherein the design is a logo of a sports team.

35. The method of claim 33 wherein the design creates a tongue tattoo when dissolved on a tongue of a consumer.

36. A method of marketing edible thin films comprising the step of providing a plurality of edible thin films under a single distributor's name that vary in at least three of the following characteristics: flavor, shape, color, and mouth sensation.

37. The method of claim 36 wherein the geometric cross-sectional shape of the edible thin film is suggestive of a flavor of the edible thin film.

38. The method of claim 36 wherein the color of the edible thin film is suggestive of the flavor of the edible thin film.

39. The method of claim 36 wherein the flavor is chosen from the group consisting of lemon, orange, cherry, grape, and lime.

40. The method of claim 36 wherein the color is chosen from the group consisting of yellow, orange, red, purple, and green.

41. The method of claim 36 wherein edible thin films having a different flavor are packaged together.

42. The method of claim 36 wherein the edible thin film has breath freshening properties.

43. A method of marketing edible thin films comprising the steps of:
providing a plurality of edible thin films that provide a different characteristic chosen from the group consisting of flavor, taste, and mouth sensation; and
packaging the edible thin film in a package that is suggestive of the different flavor, taste, or mouth sensation due to the shape, color or indicia on the package.

44. A method of claim 43 wherein the container includes a body that has substantially the same cross-sectional shape as the edible thin film.

45. The method of claim 43 wherein the body has portions thereof that are of a same color as the edible thin film.

46. A method of marketing edible thin films comprising the step of providing edible thin films comprising a film former and flavor, the edible thin film having a first portion and a second portion, the first and second portion having different colors that extend for an entire length, width, or depth of the film.

47. The method of claim 46 wherein the edible thin film provides at least two flavors to a consumer consuming the edible thin film.

48. The method of claim 46 wherein at least one side of the edible thin film includes a design.

49. The method of claim 46 wherein the edible film releases color to dye a tongue of the consumer when dissolved in the mouth of a consumer.

50. The method of claim 46 wherein the edible thin film is so constructed and arranged so as to create a tongue tattoo when dissolved in the mouth of a consumer.

51. The method of claim 46 wherein the edible thin film includes ingredients that create an oral sensation as the film dissolves in the mouth of a consumer.

52. A method for marketing confectionery products comprising at least two different types of confections under a single brand name wherein the different forms are combined in a single package in which the single package comprises separate compartments suitable for dispensing each form.

53. The method of claim 52, wherein the separate compartments of the single package are refillable and the refills can be purchased separately from the single package.

54. The method of claim 52, wherein at least the two types of confectionery products are in individual primary packaging suitable for dispensing each form and the primary packaging for each form are then combined with a secondary packaging element, containing a brand identifying element common to the primary packaging comprising a packaging chosen from the group consisting of plastic overwrap, metal tin, vacuum formed plastic mold, injection molded plastic, and corrugated or paper board box providing a single offering for sale.

55. The method of claim 52, wherein the single brand name in which the different confections are packaged in packaging which contains at least one single common element to each confectionery form.
